(19) United States
(12) Patent Application Publication
(10) Pub. No.: US 2016/0348702 A1
(43) Pub. Date: Dec. 1, 2016

(54) DEVICE CONFIGURED FOR PRELOADING BEARING INTERFACES COUPLING CONCENTRICALLY ARRANGED TUBES

(71) Applicant: Craig Hawley Edwards, La Canada, CA (US)

(72) Inventor: Craig Hawley Edwards, La Canada, CA (US)

(21) Appl. No.: 14/724,919

(22) Filed: May 29, 2015

(51) Int. Cl. F16B 7/18

(52) U.S. Cl. CPC F16B 7/18

(57) ABSTRACT

Embodiments of the present invention are directed generally to devices for imparting preload on mechanical structures. More specifically, embodiments of the present invention are directed to a preload device that is relatively lightweight, simple to use and inexpensive to manufacture and that is specifically configured for imparting a preload on bearing interfaces coupling concentrically arranged tubes. In some embodiments, a steerer tube of a bicycle fork and a head tube of a bicycle frame are the concentrically arranged tubes.

### FIELD OF THE DISCLOSURE

The disclosures made herein relate generally to preloading of bearing interfaces and, more particularly, to devices configured for imparting a preload on bearing interfaces coupling concentrically arranged tubes.

### BACKGROUND

It is well known that a fork assembly of a bicycle is attached to a head tube of a bicycle frame through a plurality of bearing interfaces. For example, a steerer tube of the fork is generally mounted on the head tube through upper and lower bearing interfaces. Typically, the upper and lower bearing interfaces each include a bearing and one or more bearing races that are jointly configured to allow for rotation of the steer tube with respect to the head tube and to positively locate the steer tube radially and axially with respect to the head tube. In this respect, the steerer tube and the head tube are examples of concentrically arranged tubes.

It is also well known that the failure to maintain an adequate preload between each one of the bearing interfaces can lead to one or more adverse situation. One such adverse situation is damage or premature wear of the bearing and/or one or more races due to excessive or inadequate preload. Another such adverse situation is unpredictable steering of the bicycle due to inadequate preload that leads to radial movement of the steerer tube (and thus fork) with respect to the head tube (i.e., the frame). Still another such adverse situation is unpredictable steering of the bicycle due to excessive preload that inhibits smooth, effortless and controlled rotational movement of the steerer tube with respect to the head tube.

Thus, a device that is relatively lightweight, simple to use and inexpensive to manufacture and that is specifically configured for imparting a preload on bearing interfaces coupling concentrically arranged tubes would be advantageous, desirable and useful.

### SUMMARY OF THE DISCLOSURE

Embodiments of the present invention are directed generally to imparting preload on mechanical structures. More specifically, embodiments of the present invention are directed to a device that is relatively lightweight, simple to use and inexpensive to manufacture and that is specifically configured for imparting a preload on bearing interfaces coupling concentrically arranged tubes. In some embodiments, a steerer tube of a bicycle fork and a head tube of a bicycle frame are the concentrically arranged tubes. However, in view of the disclosure made herein, a skilled person will recognize that embodiments of the present invention are not limited to any particular application of concentrically arranged tubes.

In one embodiment of the present invention, a device comprises an inner tube binder, an inner tube mount, and a binder fastener. The inner tube binder includes at least two binder elements. A first one of the binder elements includes a plurality of inner tube engaging elements. The inner tube engaging elements of the first one of the binder elements are attached to and extend outwardly from a base portion thereof. At least a portion of the inner tube engaging elements of the first one of the binder elements each has a terminal end portion abutting a mating portion of the second one of the binder elements. A base portion of the inner tube mount is engaged with a first end portion of the inner tube binder for inhibiting unrestricted displacement of the first end portion of the inner tube binder along a length of the inner tube mount. The binder fastener has a second end portion of the inner tube binder engaged therewith in a manner that inhibits unrestricted displacement of the second end portion of the inner tube binder along a length of the binder fastener. The binder fastener is in threaded engagement with the inner tube mount for allowing a compressive force to be exerted on the inner tube binder through relative rotation of the binder fastener with respect to the inner tube mount thereby causing outward deflection of at least a portion of the inner tube engaging elements of the first one of the binder elements.

In another embodiment of the present invention, a kit configured for preloading bearing interfaces between first and second concentrically arranged tubes comprises an inner tube binder, an inner tube mount, and a binder fastener. The inner tube binder includes a pair of binding structures each including a plurality of inner tube engaging fingers. The inner tube engaging fingers of each one of the binding structures are attached to and extend outwardly from a respective base portion thereof. At least a portion of the inner tube engaging fingers of a first one of the binding structures have a terminal end portion that abuts a terminal end portion of at least one of the inner tube engaging fingers of a second one of the binding structures. The inner tube mount includes an inner tube engaging portion, an inner tube binder engaging portion and a binder fastener engaging portion. The inner tube binder engaging portion of the inner tube mount and a first end portion of the inner tube binder are jointly configured for allowing the inner tube binder engaging portion of the inner tube mount to be engaged with the first end portion of the inner tube binder in a manner that inhibits unrestricted displacement of the first end portion of the inner tube binder along a length of the inner tube mount. The binder fastener includes an inner tube binder engaging portion and an inner tube mount engaging portion. The inner tube binder engaging portion of the binder fastener and a second end portion of the inner tube binder are jointly configured for allowing the inner tube binder engaging portion of the binder fastener to be engaged with the second end portion of the inner tube binder in a manner that inhibits unrestricted displacement of the second end portion of the inner tube binder along a length of the binder fastener. The binder fastener is threadedly engageable with the inner tube mount for allowing a compressive force to be exerted on the inner tube binder through relative rotation of the binder fastener with respect to the inner tube mount thereby causing outward deflection of at least a portion of the inner tube engaging fingers of the binding structures.

In another embodiment of the present invention, a device comprises a cap, an inner tube mount, an inner tube binder, a binder fastener, and a cap fastener. The cap includes a central passage and an outer tube engaging structure concentrically encompassing the central passage thereof. The inner tube mount includes a central passage that extends therethrough. An upper end portion of the inner tube mount includes an inner tube engaging structure at least partially encompassing the central passage thereof. The inner tube binder has opposing end portions and a central passage extending therethrough. A first one of the end portions of the inner tube binder is engaged with a lower end portion of the inner tube mount. The inner tube binder includes at least two binding structures between the opposing end portions thereof. Each one of the binding structures has a conically shaped portion including a plurality of inner tube engaging fingers. The inner tube engaging fingers of each one of the binding structures extend outwardly from a base portion thereof to which each one of the inner tube engaging fingers thereof is attached. At least a portion of the inner tube engaging fingers of a first one of the binding structures have a terminal end portion that abuts a terminal end portion of at least one of the inner tube engaging fingers of the second one of the binding structures. The binder fastener includes a central passage extending therethrough. The lower end portion of the inner tube binder is seated on an exterior surface of the binder fastener. The lower end portion of the inner tube mounting structure is in threaded engagement with the binder fastener. The cap fastener includes a head portion and a shank portion connected to the head portion. The head portion is seated against a top surface of the cap and the shank portion extends through the central passage of the cap into threaded engagement with the binder fastener.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a first perspective view showing a device configured in accordance with an embodiment of the present invention;

FIG. 2 is a second perspective view of the device shown in FIG. 1;

FIG. 3 is a cross-sectional view taken along the line 3-3 in FIG. 1; and

FIG. 4 is a first exploded view of the device shown in FIG. 1;

FIG. 5 is a second exploded view of the device shown in FIG. 1; and

FIG. 6 is a fragmentary plan view of a toothed-edge portion of a binding structure of a device in accordance with an embodiment of the present invention.

### DETAILED DESCRIPTION

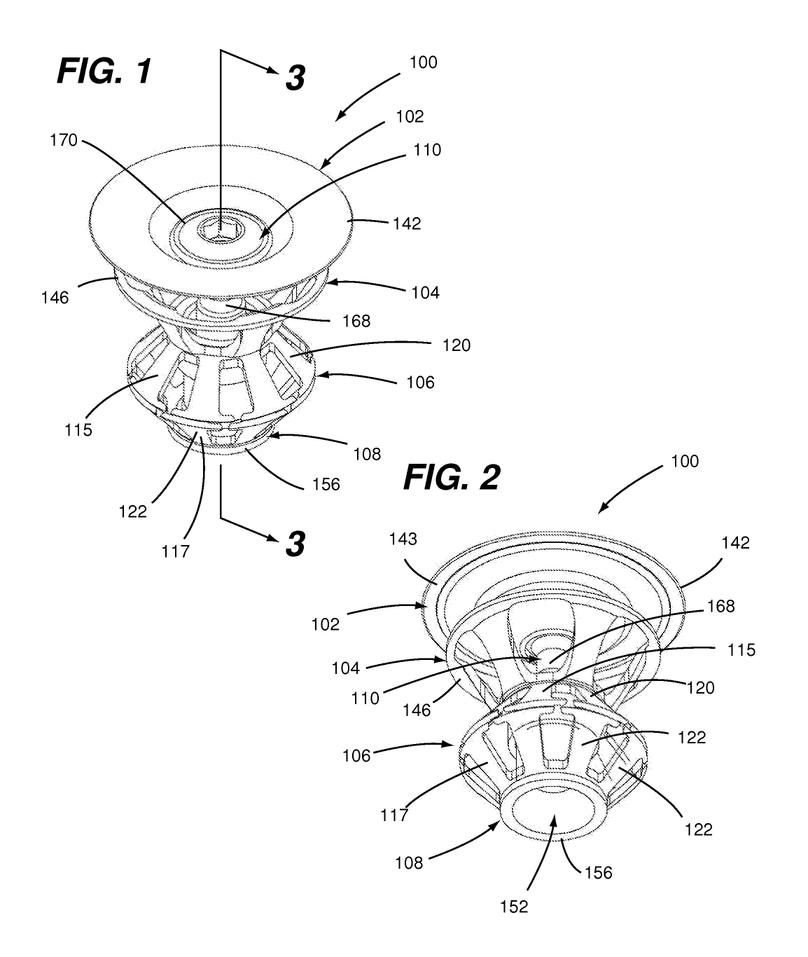

FIGS. 1-5 show various aspects of a device 100 configured in accordance with an embodiment of the present invention. The device 100 includes a cap 102, an inner tube mount 104, an inner tube binder 106, a binding structure fastener 108, and a cap fastener 110. As described below in greater detail, these components of which the device 100 is comprised interact to for enabling the device 100 to impart preload on bearing interfaces (not specifically shown) that rotatably couple an inner tube 112 (i.e., an first tube such as, for example, steerer tube of a bicycle fork) to an outer tube 114 (i.e., a second tube such as, for example, a combination of a head tube of a bicycle frame and handlebar stem mount) in a concentrically arranged manner. Furthermore, as also discussed below in greater detail, the configuration of these components of which the device 100 is comprised allow the device 100 to be relatively lightweight, simple to use and inexpensive to manufacture.

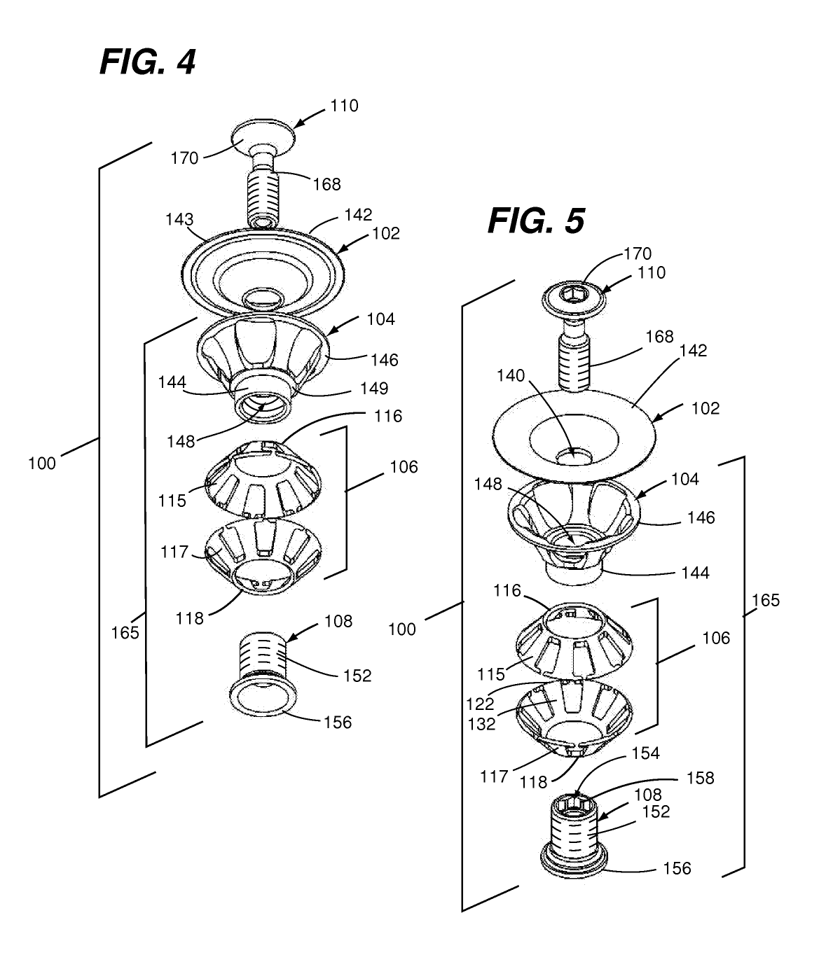

Still referring to FIGS. 1-5, the inner tube binder 106 includes an upper binding structure 115 and a lower binding structure 117. In this respect, the upper binding structure 112 and a lower binding structure 114 are examples of elements of the inner tube binder 106 (i.e., binder elements). The binding structures 115, 117 each include a base portion (116 and 118, respectively) and a plurality of fingers (120 and 122, respectively) that extend from the respective base portion 116, 118. The base portion 116, 118 of the binding structures 115, 117 each have a central passage (124 and 126, respectively) extending therethrough, which is best shown in FIG. 4. When the binding structures 115, 117 are arranged for operation (as shown in FIGS. 1-3), the base portions 116, 118 thereof define opposing end portions of the inner tube binder 106 and the central passages 124, 126 thereof jointly define a central passage of the inner tube binder 106.

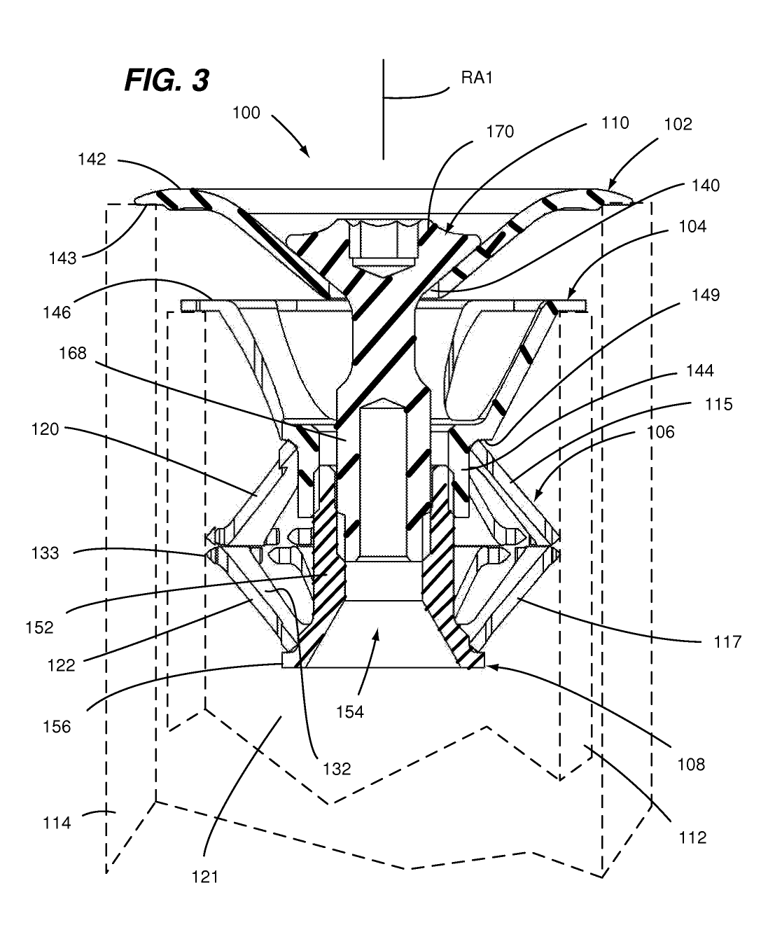

The fingers 120, 122 of each one of the binding structures 115, 117 extend outwardly from the base portion 116, 118 to which they are attached. As shown in FIGS. 1-5, the binding structures 115, 117 can be substantially identical instances of each other that are in a stacked arrangement such that fingers 120 of the upper binding structure 115 extend toward the fingers 122 of the lower binding structure 117. As discussed below in greater detail, during operation of the device 100, force is exerted on the fingers 120, 122 of each one of the binding structures 115, 117 through relative displacement of the binding structures 115, 117 toward each other, thereby causing the fingers 120, 122 of each one of the binding structures 115, 117 to deflect further outward and thus into engagement with an inner surface 121 of the inner tube 112, as shown in FIG. 3. In this respect, the fingers 120, 122 are examples of inner tube engaging elements.

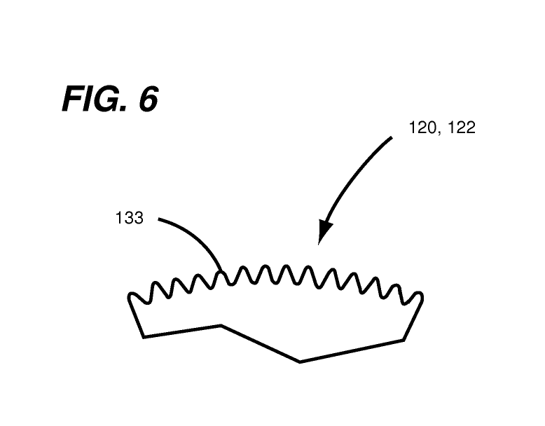

Outward extension of the fingers 120, 122 of each one of the binding structures 115, 117 can be accomplished in a variety of configurations. One such configuration, shown in the embodiment of the present invention depicted in FIGS. 1-5, is for each one of the fingers 120, 122 of the respective one of the binding structures 115, 117 to be substantially flat and to extend outward in an angle (i.e., skewed fashion) with respect to a centerline longitudinal reference axis RA1 of the device 100 (shown in FIG. 3), thereby creating a binding structure that has a conical shape. This configuration is particularly applicable in embodiments of the present invention where fingers 120, 122 of the upper and lower binding structures 115, 117 are substantially flat with their terminal end portions in tip-to-tip contact, such as shown in FIGS. 1-3 (i.e., where displacement of the upper and lower binding structures 115, 117 toward each other causing further outward deflection of the fingers 120, 122 thereof). This configuration is particularly applicable in embodiments of the present invention where the upper binding structure 115 is replaced by an upper binder element such as a ring or plug that engages a top surface 132 of the fingers 122 of the lower binding structure 117 (i.e., where displacement of the upper binder element and lower binding structures 117 toward each other causing further outward deflection of the fingers 122 thereof). Another such configuration, which is particularly applicable where the upper binding structure 115 is replaced by a binder element such as a ring or plug that engages a top surface of the fingers 122 of the lower binding structure 117 (not shown), is for each of the fingers 122 to have a slight curvature. Additionally, as shown in FIG. 6, the outermost edge portion 133 one or more of the fingers 120, 122 can have a surface engagement modifier such as teeth, ridges, or other friction enhancing feature(s).

Preferably, but not necessarily, the fingers 120, 122 of each one of the binding structures 115, 117 is detached at the terminal end portion thereof from each adjacent one of the fingers 120, 122 thereof. Such detachment allows the terminal end portion of each one of the inner tube engaging fingers 120, 122 of each one of the binding structures 115, 117 to move independently with respect to each adjacent one of the fingers thereof 115, 117. This independent movement is beneficial to the intended functionality of the outermost edge portion 133 of the fingers 120, 122 of each one of the binding structures 115, 117 being outwardly displaced into biting engagement with an interior surface 121 of the inner tube 112, as shown in FIG. 3.

The cap 102 includes a central passage 140 (best shown in FIGS. 3-5) and an outer tube engaging structure 142 that defines a seating surface 143 (best shown in FIGS. 2 and 3, that engages an upper end face of the outer tube 114. Preferably, but not necessarily, the outer tube engaging structure 142 concentrically encompasses the central passage 140 of the cap 102.

The inner tube mount 104 includes mounting boss 144 (best shown in FIGS. 3-5) and, optionally, can include an inner tube engaging structure 146 (e.g. portion of the inner tube mount 104 that is in the form of a flange that engages an end face of the inner tube). The inner tube engaging structure 146 preferably, but not necessarily, fully encompasses the mounting boss 144. In some embodiments (e.g., as shown in FIGS. 1-5), the inner tube engaging structure 146 is axially offset from the mounting boss 144. A central passage 148 extends through the mounting boss 144 and is accessible through the inner tube engaging structure 146. At least a portion of the surface defining the central passage 148 of the mounting boss 144 of the inner tube mount 104 is threaded, as best shown in FIGS. 3-5. The mounting boss 144 includes a binding structure engaging shoulder 149 (best shown in FIGS. 3 and 5). The inner tube mount 104 and the inner tube binder 106 are jointly configured such that an upper end portion of the inner tube binder 106 can be seated against the binding structure engaging shoulder 149 of the inner tube mount 104 when the mounting boss 144 is situated within the central passage of the inner tube binder 106.

The binding structure fastener 108 (i.e., also referred to herein as a binder fastener), as shown in FIGS. 1-5, includes an extension portion 152, a central passage 154 within the extension portion 152, and a binding structure engaging flange 156 extending from the extension portion 152. A portion of an exterior surface of the extension portion 152 is treaded for allowing the binding structure fastener 108 to be threadedly engaged with the mounting boss 144 of the inner tube mount 104 via threads within the central passage 148 of the mounting boss 144 of the inner tube mount 104. The binding structure fastener 108 and the inner tube binder 106 are jointly configured such that a lower end portion of the inner tube binder 106 can be seated against the binding structure engaging flange 156 of the binding structure fastener 108 with the extension portion 152 situated within the central passage of the inner tube binder 106.

At one or both end portions of the binding structure fastener 108, the binding structure fastener 108 includes a torque imparting feature 158 that can be engaged by a suitable tool for enabling rotation of the binding structure fastener 108. For example, as shown in FIG. 4, a portion of the central passage 154 can have a shape for allowing a suitable tool to be engaged therein (i.e., a torque imparting feature 158 having a hex shape for being engaged by an Allen wrench). At least a portion of the surface defining the central passage 152 of the binding structure fastener 108 is threaded, as best shown in FIGS. 3-5.

As shown in FIGS. 1-3, in an assembled state, the inner tube binder 106 is situated between the inner tube mount 104 and the binding structure fastener 108. The mounting boss 144 of the inner tube mount 104 extends into the central passage of the inner tube binder 106 though an upper end portion of the inner tube binder 106. The extension portion 152 of the binding structure fastener 108 extends into the central passage of the inner tube binder 106 through a lower end portion of the inner tube binder 106. In this arrangement, the inner tube binder 106 is captured between the binding structure engaging shoulder 149 of the inner tube mount 104 and the binding structure engaging flange 156 of the binding structure fastener 108. This assembly is referred to herein as the binder assembly 165, as shown in FIGS. 3-5.

Through the threaded engagement of the mounting boss 144 of the inner tube mount 104 with the extension portion 152 of the binding structure fastener 108, a compressive force can be exerted on the inner tube binder 106 via relative rotation of the inner tube mount 104 and the binding structure fastener 108 such as through application of rotational force of the binding structure fastener 108. For example, as shown in FIG. 3, prior to installation of the cap 102 and the cap fastener 110, the binder assembly 165 is placed within the inner tube 114. Through tightening of the binding structure fastener 108 with respect to the inner tube mount 104 via a tool extending through the central passage of the inner tube mount 104 and into engagement with the torque imparting feature 158 of the binding structure fastener 108, a compressive force can be exerted on the inner tube binder 106 thereby causing outward deflection of the fingers 120, 122 of the upper and lower binding structures 115, 117 as the distance between the inner tube mount 104 and the binding structure fastener 108 is decreased. The resulting outward deflection of the fingers 120, 122 of the upper and lower binding structures 115, 117 causes the tips of the fingers 120, 122 to become forcibly engaged with the inner surface of the inner tube 114 for securing the binder assembly 165 in a fixed position with respect to the inner tube 114.

Advantageously, because the tool is engaged with the binding structure fastener 108 and not the inner tube mount 104, the user can grasp the inner tube mount 104 if necessary while initiating tightening of the tightening the binding structure fastener 108 to ensure immediate tightening of the binding structure fastener 108 with respect to the inner tube mount 104 and thus outward deflection of the fingers 120, 122. In some prior art constructions, torque is applied to an inner tube mount thereof thereby leaving a binder fastener thereof and possibly inner tube binder(s) thereof to undesirably rotate within the inner tube in concert with the inner tube mount.

With the binder assembly 165 secured in its fixed position with respect to the inner tube 114, preloading can now be provided through use of the binder assembly 165. To this end, as best shown in FIGS. 3-5, a threaded shank portion 168 of the cap fastener 110 is placed through the central passage 140 of the cap 102. Preload is set by engaging the threaded shank portion 168 with the threads within the central passage 148 of the mounting boss 144 of the inner tube mount 104 and sufficiently tightened. Through engagement of the seating surface 143 of the cap 102 with the end face of the outer tube 114 and engagement of the inner tube binder 106 with the inner tube 112, tightening of the cap fastener 110 results axial displacement of the inner tube 112 with respect to the outer tube 114. In the case where an interface structure is provided at an opposing end portion of the inner and outer tubes 112, 114 for opposing unrestricted displacement of the inner tube 112 with respect to the outer tube 114, a preload force will be generated in that interface structure. For example, in the case of a bicycle, a tapered bearing assembly is provided between a lower end of the steerer tube (i.e., the inner tube) and a lower end of the head tube (i.e., the outer tube) of the frame (i.e., the lower tapered bearing assembly), a tapered bearing assembly is provided between an upper end of the steerer tube (i.e., at the crown of the fork) and an upper end of the head tube (i.e., the upper tapered bearing assembly), and a handlebar stem mount is located around the steerer and abutting a top face of the tapered bearing assembly is provided at the upper end of the steerer tube. Tightening of the cap bolt 110 causes relative displacement of the steerer tube with respect to the head tube in a direction toward the upper end of the head tube and relative displacement of the handlebar stem mount with respect to the steerer tube in a direction toward the lower end of the head tube. In this manner, such relative displacement results in generation of compressive axial preload force within the upper and lower tapered bearing assemblies.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A device, comprising:
an inner tube binder including at least two binder elements, wherein a first one of the binder elements includes a plurality of inner tube engaging elements, wherein the inner tube engaging elements of the first one of the binder elements are attached to and extend outwardly from a base portion thereof, wherein at least a portion of the inner tube engaging elements of the first one of the binder elements each has a terminal end portion abutting a mating portion of a second one of the binder elements;
an inner tube mount including a base portion thereof that is engaged with a first end portion of the inner tube binder that inhibits unrestricted displacement of the first end portion of the inner tube binder along a length of the inner tube mount; and
a binder fastener having a second end portion of the inner tube binder engaged therewith in a manner that inhibits unrestricted displacement of the second end portion of the inner tube binder along a length of the binder fastener, wherein the binder fastener is in threaded engagement with the inner tube mount for allowing a compressive force to be exerted on the inner tube binder through relative rotation of the binder fastener with respect to the inner tube mount thereby causing outward deflection of at least a portion of the inner tube engaging elements of the first one of the binder elements.

2. The device of claim 1 wherein the first one of the binder elements has a conically shaped portion including the inner tube engaging elements thereof.

3. The device of claim 1 wherein an outermost edge at the terminal end portion of each one of the inner tube engaging elements of the first one of the binder elements includes a plurality of teeth.

4. The device of claim 1 wherein:
the inner tube engaging elements are detached from each adjacent one of the inner tube engaging elements at the terminal end portion thereof thereby allowing the terminal end portion of each one of the inner tube engaging elements to move independently with respect to each adjacent one of the inner tube engaging elements; and
the binder fastener includes a torque imparting feature configured for being engaged with a tool through the central passage of the inner tube mount.

5. The device of claim 1 wherein the mating portion of the second one of the binder elements is in contact with a side surface of the at least a portion of the inner tube engaging elements of the first one of the binder elements adjacent to the terminal end portion thereof.

6. The device of claim 5 wherein the mating portion of the second one of the binder elements is an outer edge portion thereof that fully encompasses a central passage within a base portion thereof.

7. The device of claim 1 wherein:
the mating portion of the second one of the binder elements includes a plurality of inner tube engaging elements each having a terminal end portion;
the terminal end portion of at least a portion of the inner tube engaging elements of the first one of the binder elements abut the terminal end portion of at least one of the inner tube engaging elements of the second one of the binder elements

8. The device of claim 7 wherein the first and second binder elements each have a conically shaped portion including the inner tube engaging elements thereof.

9. The device of claim 8 wherein the first and second binder elements are substantially identical instances of each other that are in a stacked arrangement such that the inner tube engaging elements of the first one of the binder elements extend toward the inner tube engaging elements of the second one of the binder elements.

10. The device of claim 9 wherein:
the first one of the binder elements and the second one of the binder elements are separate structures; and
the inner tube engaging elements of each one of the binder elements is detached from each adjacent one of the inner tube engaging elements at the terminal end portion thereof thereby allowing the terminal end portion of each one of the inner tube engaging elements of each one of the binder elements to move independently with respect to each adjacent one of the inner tube engaging elements thereof.

11. The device of claim 7 wherein:
the first one of the binder elements and the second one of the binder elements are separate structures; and
the inner tube engaging elements of each one of the binder elements is detached from each adjacent one of the inner tube engaging elements at the terminal end portion thereof thereby allowing the terminal end portion of each one of the inner tube engaging elements of each one of the binder elements to move independently with respect to each adjacent one of the inner tube engaging elements thereof.

12. A kit configured for preloading bearing interfaces between first and second concentrically arranged tubes, comprising:
an inner tube binder including a pair of binding structures each including a plurality of inner tube engaging fingers, wherein the inner tube engaging fingers of each one of the binding structures are attached to and extend outwardly from a respective base portion thereof and wherein at least a portion of the inner tube engaging fingers of a first one of the binding structures have a terminal end portion that abuts a terminal end portion of at least one of the inner tube engaging fingers of a second one of the binding structures;
an inner tube mount including an inner tube engaging portion, an inner tube binder engaging portion and a binder fastener engaging portion, wherein the inner tube binder engaging portion of the inner tube mount and a first end portion of the inner tube binder are jointly configured for allowing the inner tube binder engaging portion of the inner tube mount to be engaged with the first end portion of the inner tube binder in a manner that inhibits unrestricted displacement of the first end portion of the inner tube binder along a length of the inner tube mount; and
a binder fastener including an inner tube binder engaging portion and an inner tube mount engaging portion, wherein the inner tube binder engaging portion of the binder fastener and a second end portion of the inner tube binder are jointly configured for allowing the inner tube binder engaging portion of the binder fastener to be engaged with the second end portion of the inner tube binder in a manner that inhibits unrestricted displacement of the second end portion of the inner tube binder along a length of the binder fastener, wherein the binder fastener is threadedly engageable with the inner tube mount for allowing a compressive force to be exerted on the inner tube binder through relative rotation of the binder fastener with respect to the inner tube mount thereby causing outward deflection of at least a portion of the inner tube engaging fingers of the binding structures, and wherein the binder fastener includes a torque imparting feature configured for being engaged with a tool through a central passage of the inner tube mount.

13. The kit of claim 12 wherein each one of the binding structures has a conically shaped portion including the inner tube engaging fingers thereof.

14. The kit of claim 12 wherein an outermost edge at the terminal end portion of each one of the inner tube engaging fingers of each one of the binding structures includes a plurality of teeth.

15. The kit of claim 12 wherein the binding structures are substantially identical instances of each other that are in a stacked arrangement such that the inner tube engaging fingers of the first one of the binding structures extend toward the inner tube engaging fingers of the second one of the binding structures.

16. The kit of claim 12 wherein the inner tube engaging fingers of each one of the binding structures is detached from each adjacent one of the inner tube engaging fingers at the terminal end portion thereof thereby allowing the terminal end portion of each one of the inner tube engaging fingers of each one of the binding structures to move independently with respect to each adjacent one of the inner tube engaging fingers thereof.

17. A device, comprising:
a cap including a central passage and an outer tube engaging structure concentrically encompassing the central passage thereof;
an inner tube mount including a central passage that extends therethrough, wherein an upper end portion of the inner tube mount includes an inner tube engaging structure at least partially encompassing the central passage thereof;
an inner tube binder having opposing end portions and a central passage extending therethrough, wherein a first one of the end portions of the inner tube binder is engaged with a lower end portion of the inner tube mount, wherein the inner tube binder includes at least two binding structures between the opposing end portions thereof, wherein each one of the binding structures has a conically shaped portion including a plurality of inner tube engaging fingers, wherein the inner tube engaging fingers of each one of the binding structures extend outwardly from a base portion thereof to which each one of the inner tube engaging fingers thereof is attached and wherein at least a portion of the inner tube engaging fingers of a first one of the binding structures have a terminal end portion that abuts a terminal end portion of at least one of the inner tube engaging fingers of the second one of the binding structures;
a binder fastener including a central passage extending therethrough, wherein the lower end portion of the inner tube binder is seated on an exterior surface of the binder fastener and wherein the lower end portion of the inner tube mounting structure is in threaded engagement with the binder fastener; and
a cap fastener includes a head portion and a shank portion connected to the head portion, wherein the head portion is seated against a top surface of the cap and wherein the shank portion extends through the central passage of the cap into threaded engagement with the binder fastener.

18. The device of claim 17 wherein an outermost edge at the terminal end portion of each one of the inner tube engaging fingers of each one of the binding structures includes a plurality of teeth.

19. The device of claim 17 wherein:
the binding structures are substantially identical instances of each other that are in a stacked arrangement such that the inner tube engaging fingers of the first one of the binding structures extend toward the inner tube engaging fingers of the second one of the binding structures; and
the binder fastener includes a torque imparting feature configured for being engaged with a tool through the central passage of the inner tube mount.

20. The device of claim 17 wherein the inner tube engaging fingers of each one of the binding structures is detached from each adjacent one of the inner tube engaging fingers at the terminal end portion thereof thereby allowing the terminal end portion of each one of the inner tube engaging fingers of each one of the binding structures to move independently with respect to each adjacent one of the inner tube engaging fingers thereof.
